(19) United States
(12) Patent Application Publication
(10) Pub. No.: US 2008/0294501 A1
(43) Pub. Date: Nov. 27, 2008

(54) COLLECTING AND PROVIDING INFORMATION ABOUT VENDORS, PRODUCTS AND SERVICES

(76) Inventor: Steven Carl Rennich, Belmont, CA (US)

Correspondence Address: RAUBVOGEL LAW OFFICE, 820 LAKEVIEW WAY, REDWOOD CITY, CA, 94062, US

(21) Appl. No.: 12/112,421

(22) Filed: Apr. 30, 2008

Related U.S. Application Data
(60) Provisional application No. 60/931,130, filed on May 21, 2007.

(51) Int. Cl. G06Q 10/00

(52) U.S. Cl. 705/10

(57) ABSTRACT

The utility, reliability and efficiency of vendor, product and/or service ratings are improved by collecting verifiable transaction information along with consumer-supplied ratings indicating consumer satisfaction regarding the corresponding goods, services, and/or vendors. From this collected information, the method and system of the present invention generates a score or set or scores for the vendors, products, and/or services. The score or scores generated by the present invention is a transaction-price-weighted function of the consumer's transaction satisfaction, taking into account not only the consumer-supplied ratings but also providing greater reliability and accuracy by taking into account the amount of money each consumer spent on the goods or services. The score or scores are made available to potential consumers so that they can perform comparative analysis and thereby more easily obtain the best products and services from the best vendors.

### CROSS-REFERENCE TO RELATED APPLICATION

The present application claims priority from U.S. Provisional Patent Application No. 60/931,130, filed on May 21, 2007 and entitled “Method and Apparatus for Ranking Vendors, Products, and Services,” the disclosure of which is incorporated herein by reference.

### FIELD OF THE INVENTION

The present invention relates to collecting and providing information about vendors, products, and services to potential consumers, and more particularly to systems and methods for improving the reliability and usefulness of such information.

### DESCRIPTION OF THE RELATED ART

Consumers often lack sufficient information about products and services they are considering purchasing, or information about the vendors or providers of such products and services. This lack of information can result in poor purchase decisions; specifically, the consumer may end up dissatisfied with the product, service, or vendor. In many cases, pre-purchase availability of robust and reliable information can educate the consumer so as to avoid such dissatisfaction.

It is desirable, therefore, to provide such improved information before purchases are made. Such information leads to better purchasing decisions, increases the value received for dollars spent, and provides vendors, manufacturers, and service providers with an incentive to improve the quality of their goods and services.

Certain situations are particularly prone to poor decision-making on the part of consumers, due to insufficient information. In particular, consumers often lack information when making large purchases from vendors that do not usually have frequent repeat business (such as hiring a specific type of contractor, installing a home alarm system, or hiring a caterer). Information can also be lacking when a consumer is making purchases from local vendors in an unfamiliar city, so that the consumer is not well acquainted with the quality of such vendors.

Existing mechanisms attempt to correct the above-stated problems. In some cases, goods can be returned for a refund, although there may be significant costs in terms of time and effort. In other cases, ratings are available from guidebooks, websites, or entities such as the Better Business Bureau, Consumers Union, Zagat, or the American Automobile Association. Friends and acquaintances can be consulted, so that vendor quality assessments (both positive and negative) can be communicated from one person to another.

Though valuable, such mechanisms suffer from several limitations. For example, many of the mechanisms listed above have relatively narrow coverage. They often do not rate small vendors at all, listing only a subset of the available products and services, and limiting the ratings to a narrow segment of products, services, or vendors.

Online rating services and product ratings within retailers have their own limitations. Most notably, they are prone to manipulation and are therefore unreliable. Many let anybody rate anything, thus allowing a vendor or service provider to rate himself, perhaps with multiple aliases, in order to artificially improve the overall quality assessment. There is generally no mechanism to ensure that a reviewer of a product or service actually purchased the product or service; in some cases, reviews may be posted based on reputation, anticipation, or other reasons, thus compromising the reliability of the online recommendations.

Online auction sites, such as e-Bay, provide feedback scores indicative of the quality of previous buyers' experiences with a seller. Reliability is improved by collecting feedback scores only from known purchasers from a particular seller. However, such mechanisms are typically limited to purchase/seller relationships resulting from the auction site itself, and do not provide any measure of quality for vendors that offer their products and services outside the realm of the auction site. Accordingly, these mechanisms are not effective for providing consumers with information in many of the situations described previously, such as hiring a contractor or selecting a restaurant in an unfamiliar city.

What is needed is an improved mechanism for collecting and providing information about vendors, products, and services, which avoids the problems and limitations of existing systems. What is further needed is a system and method that cannot easily be manipulated and that therefore provides greater reliability. What is further needed is a system and method that is not limited to a specific domain, website, consumer arena, or the like, but that can be used as a global rating system encompassing all areas of commerce. What is further needed is a system and method that can provide scores and rankings that are targeted to a particular individual or in response to a particular query. What is further needed is a system and method that can score vendors' products and services in multiple ways.

### SUMMARY OF THE INVENTION

The present invention is a method and system for improving the reliability and effectiveness of consumer-supplied ratings. Verifiable transaction information is collected, along with consumer-supplied ratings indicating consumer satisfaction regarding the corresponding goods, services, and/or vendors. From this collected information, the method and system of the present invention generates a score for the vendors, products, and/or services. The score generated by the present invention includes a transaction-price-weighted function of the consumer's transaction satisfaction, taking into account not only the consumer-supplied ratings but also providing greater reliability and accuracy by taking into account the amount of money each consumer spent on the goods or services. A ranked list of scores can be generated and made available to potential consumers so that they can quickly and easily perform comparative analysis and thereby obtain the best products and services from the best vendors.

The present invention can also take into account individual characteristics of users, and thereby provide ratings that are targeted to a particular individual or in response to a particular query. Thus, users can see information that is of particular value to them.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 is a block diagram depicting an overview of operation of the present invention according to one embodiment.

FIG. 2 is a flowchart depicting a method of collecting transaction-price-weighted scores for vendors, products, and/or services according to one embodiment.

FIG. 3 is a flowchart depicting a method of providing transaction-price-weighted scores for vendors, products, and/or services to potential consumers, according to one embodiment.

FIG. 4 is a flow chart depicting a scoring algorithm according to one embodiment.

FIG. 5 depicts an example of a screen shot showing scores, as presented by an embodiment of the invention.

### DETAILED DESCRIPTION OF THE EMBODIMENTS

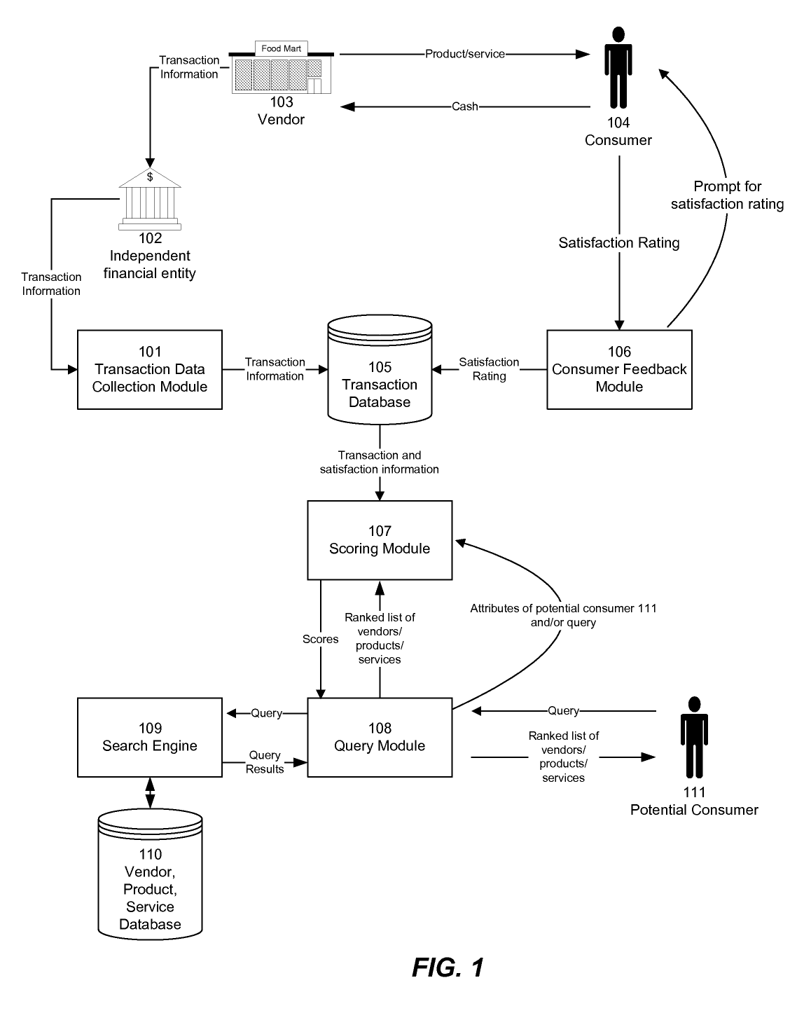

Referring now to FIG. 1, there is shown a block diagram depicting an overview of operation of the present invention according to one embodiment. In one embodiment, the invention is implemented in a client/server environment, wherein some components are implemented in a central server, while consumers and potential consumers interact with the system via a client such as a web browser. In other embodiments, consumers interact with the system via other means, such as by point-of-sale input devices, cell phones, a voice-activated telephone interface, and the like.

In other embodiments, the invention can be implemented as a standalone system, where no communication with outside components is needed.

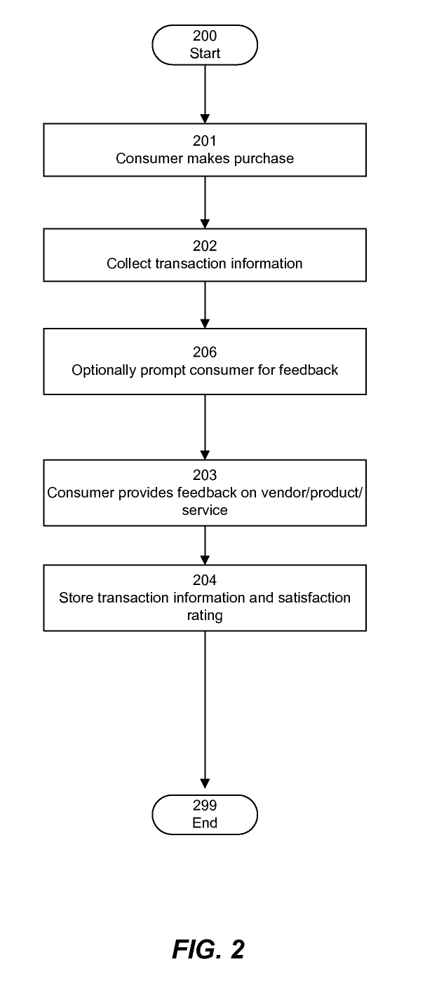

Referring also to FIG. 2, there is shown a flowchart depicting a method of collecting transaction-price-weighted scores for vendors, products, and/or services according to one embodiment.

A consumer 104 purchases 201 a product or service from a vendor 103. The consumer 104 pays for the product or service with cash, credit card, check or other means. Transaction information for the purchase is transmitted to an independent financial entity 102 such as a bank or credit card issuer.

A transaction data collection module 101 collects 202 transaction information from the financial entity 102. The collection of data may take place in real-time, as the transaction takes place, or it can take place in a batched configuration wherein several transactions uploaded to the module 101 at a time, for example daily or on some periodic basis.

In one embodiment, the transaction data collection module 101 collects information identifying and/or describing the consumer, the vendor and the transaction amount. Additional data can also be collected, such as details about the consumer (age, sex, income bracket), details about the vendor and/or the product or service purchased, and the like. In another embodiment, data regarding the details of the consumer and/or the vendor is collected in advance (for example, when the consumer signs up for the service) and stored in the database 105, so that it is not collected at the time of transaction data collection.

By collecting the transaction information from the independent financial entity 102, the transaction data collection module 101 ensures that the collected information is verifiable. The independent nature, as well as the possible regulation, of the information source greatly improves the reliability of the data. Examples of such information sources include credit card or debit card transaction records, records of online purchases, and the like.

In one embodiment, the consumer feedback module 106 specifically requests feedback from the consumer 104 by prompting 206 the consumer 104; in other embodiments, feedback may not necessarily be requested. The consumer 104 provides 203 feedback, including a satisfaction rating describing his or her satisfaction with the vendor, product, and/or service. In one embodiment, the satisfaction rating is provided by the consumer 104 interacting with a website in response to a query. In another embodiment, the consumer 104 may provide feedback on a device located at the point of sale. In another embodiment, the consumer 104 may provide the feedback by a telephone interface, voice recognition system, or the like. In other embodiments, the consumer's 104 satisfaction can be inferred, so that the consumer 104 need not explicitly provide a rating for the transaction. The fact that the consumer made a purchase from a merchant can, in itself, be the basis for a rating. Further, the transaction database can be mined for transactions the same consumer 104 made at similar merchants; the merchant the consumer 104 frequented the most an be given an implied higher rating and the others can be given implied lower ratings. Other inferences can be made from the consumer's 104 behavior (for example, recommendations to others, continued or repeated use of the product/service/vendor, or other detected behaviors). In this way, transactions for which the consumer 104 did not explicitly provide a rating could still be used for scoring. In some embodiments, such implied ratings can be weighted differently than explicitly rated transactions.

One skilled in the art will recognize, therefore, that the consumer satisfaction rating can be collected using any known method, including for example website, email, postal mail, wireless communication mechanism, voice, and the like. The consumer satisfaction rating can take any known form, such as for example, good/bad, rating of 1 to 5, rating of 1 to 10, and the like. The rating can refer to the transaction as a whole, or to the merchant, or to the particular product or service purchased. In one embodiment, the consumer 104 can optionally be rewarded or compensated in some way for providing a rating. Optionally, the consumer 104 can supply arbitrarily more detailed descriptions regarding the purchase.

Optionally, the ratings given by a specific consumer 104 can be normalized, according to any known technique, so that for all consumers the average rating is some specific number (such as 0.5 on a scale of 0 to 1).

A consumer feedback module 106 collects the satisfaction rating.

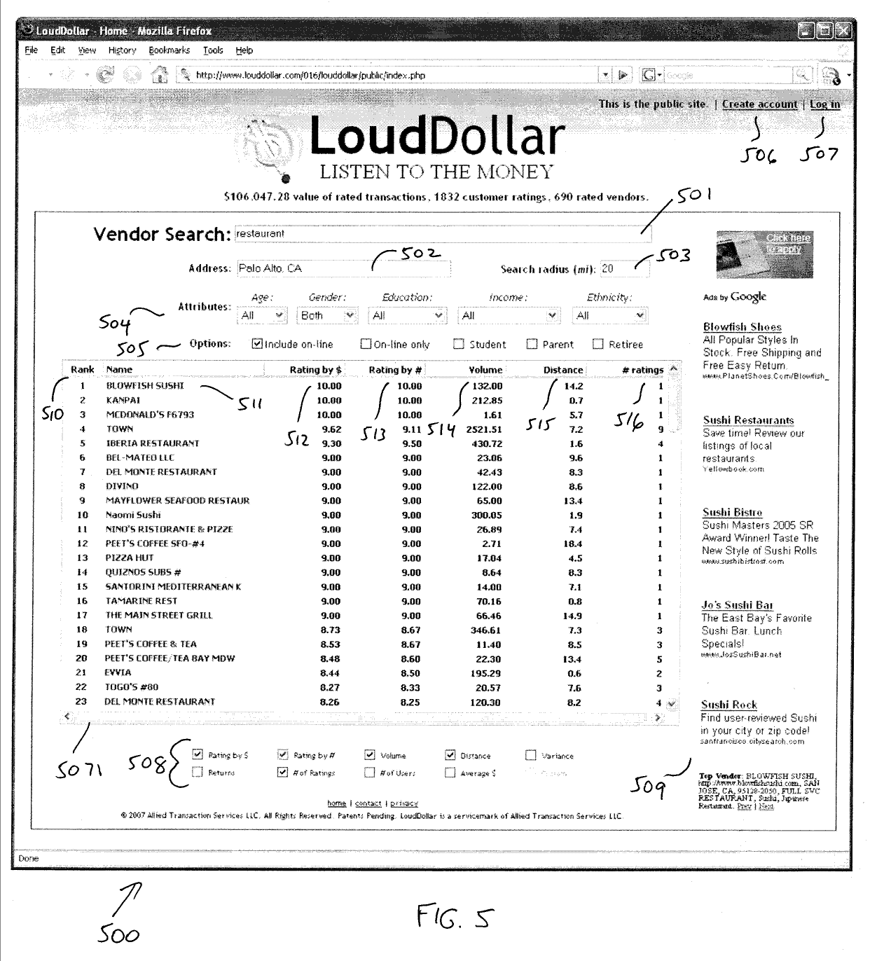

A transaction database 105 stores 204 data collected by the modules 101 and 106. The database 105 provides an aggregate data store including transaction and satisfaction data for a potentially large number of transactions. In one embodiment, the database 105 stores any additional relevant information associated with a transaction, consumer 104, and/or vendor 103, including for example specific information about consumer 104 that can be used to filter results as described below in connection with FIG. 5.

In one embodiment, scores are generated based on the stored information. These scores can be generated in advance and stored, for example in the transaction database 105, or can be generated on-the-fly in response to queries from potential consumers 111. In general, for each product/service/vendor for which data is available, a scoring module 107 generates 205 a score indicating a transaction-price-weighted aggregate satisfaction rating. Thus, each vendor, product and/or service is given a score that is a function of the transaction amount and the consumer-supplied rating. The score can take into account characteristics of the potential consumer 111 making the query.

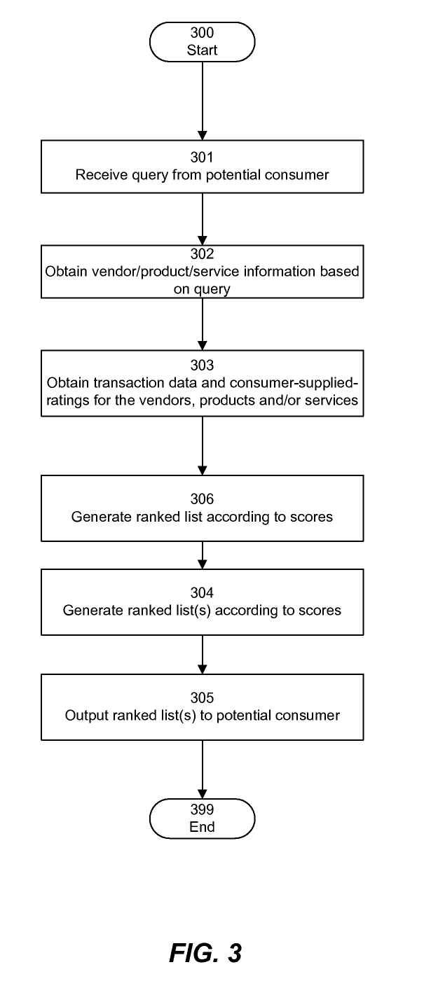

Referring also to FIG. 3, there is shown a flowchart depicting a method of providing transaction-price-weighted scores for vendors, products, and/or services to potential consumers, according to one embodiment. In one embodiment, scores are provided to potential consumers 111 in response to queries entered at a query module 108. Scores can be provided to the potential consumer 111 by any available means, such as via a web page, email, telephone call, kiosk interface, or the like.

A query module 108 receives a query 301 from a potential consumer 111. The query may be received via any known means, including for example a web page, email, telephone inquiry, kiosk, or the like. Queries can be accepted from any person, or in one embodiment queries can be accepted only from those with validated login credentials (for example, when the present invention is implemented as part of a subscription service). Queries may be of any type, including for example, requests for ratings for a certain type of vendor, product or service. Additional search parameters can also be provided, such as location, capability, price, hours, languages, or the like. Depending on the input mechanism, queries can be presented in any known format, such as for example text-based, voice-based, or the like. As well, queries can contain the attributes of the person making the query.

The query module 108 engages a search engine 109 to locate matching records in a vendor, product, and/or service database 110, so as to obtain 302 the vendor/product/service information as specified in the query. In one embodiment, the database 110 includes information for a large number of vendors, products and/or services, hierarchically categorized so that vendors, products and services of a specific type and with specific attributes can be identified easily. Optionally, additional searchable information about each vendor, product or service can be included in the database 110 as well.

The search engine 109 sends query results to the query module 108. The results can optionally be refined by further search queries submitted by the potential consumer 111 or by selection of hierarchical categories or by any other refinement method.

The scoring module 107 obtains 303 transaction data and consumer-supplied-ratings for the vendors, products and/or services specified in the query results, and generates the score(s). In one embodiment, the scoring module 107 obtains information from the transaction database 105, and optionally obtains attributes of the potential consumer 111 and/or the query entered by the potential consumer 111, and/or the ranked list of vendors/products, and/or services that was provided to the consumer 111. For example, the scoring module 107 can obtain transaction data and consumer-supplied-ratings for all transactions associated with vendors, products and/or services found in the query results, and generate 306 scores from the obtained data. In another embodiment, the scores can be pre-computed and stored in the Vendor, Product, Service Database 110; subsequently, the stored scores are obtained by the scoring module 107 as part of the vendor information. In another embodiment data can be pre-computed and stored, as necessary, in both databases 105 and 110 as well as computed in the scoring module 107 as necessary for efficient and rapid computation of scores.

A ranked list (or lists) is/are generated 304 from the obtained scores, and the ranked list(s) is/are output 305 to the potential consumer 111. In one embodiment, the ranked list(s) indicate(s) the highest-scoring vendor at the top of the list(s). In other embodiments, multiple scoring functions can be applied simultaneously to the list(s) of vendors, products and/or services and returned to the query module 108, so as to provide the potential consumer 111 with lists of matching vendors ranked in multiple ways. For example, the potential consumer 111 could be given the list of matching vendors, products and/or services ranked both by a transaction-weighted consumer-reported rating and by a consumer-equivalency weighted version. By comparing the two (or more) ranked lists, the potential consumer 111 is able to find vendors, products and/or services that consistently appeared at the top of the various lists, so as to further increase the consumer's confidence. In another embodiment, the results of two or more lists are merged, thus yielding yet another scoring function.

In one embodiment, the potential consumer 111 can further refine the query results after the ranked list is presented, for example by performing further search queries.

In one embodiment, potential consumer 111 can request the best vendor 103 for a particular product or service. This would cause the query module 108 to look only for those transactions and ratings involving that specific product or service. For example, if a store has a mediocre overall rating, but is rated very highly for some specific type of product, the potential consumer 111 can see a different rating when querying for that specific type of product than he or she would otherwise see for the store in general.

In this manner, the present invention provides the potential consumer 111 with reliable ratings based not only on consumer-supplied ratings, but also based on the number and amount of transactions engaged in by the consumers submitting their ratings. This allows the potential consumer 111 to make purchase decisions more confidently. Manipulation of scores is reduced, since only those consumers 104 that have transacted with a vendor 103 (as verified by an independent entity 102) can rate the vendor or its products and/or services. Further enhancements can also be added to reduce potential manipulation; for example the weight of multiple ratings from the same consumer for the same vendor can be successively reduced. In addition, weights can be adjusted based on some other indication of confidence in the rating offered by a consumer 104.

In yet another embodiment, rather than generating a list of the best vendors, products, or services, the system and method of present invention can be used to generate a list of vendors, products, or services to avoid. In such an implementation a list is generated including the largest vendors, products, or services (by sales volume or by some other measure) with the worst scores, ranked with the worst first.

The arrangement of components, and their connectivity, as set forth in FIG. 1 can be changed. For example, there might only be one database which handles the functions of both the transaction database 105 and the vendor, product and service database 110. As another example, the scoring module 107 can communicate directly with the search engine 109 without necessarily implementing such communication via the query module 108. Many such variations are possible.

### Scoring Algorithm

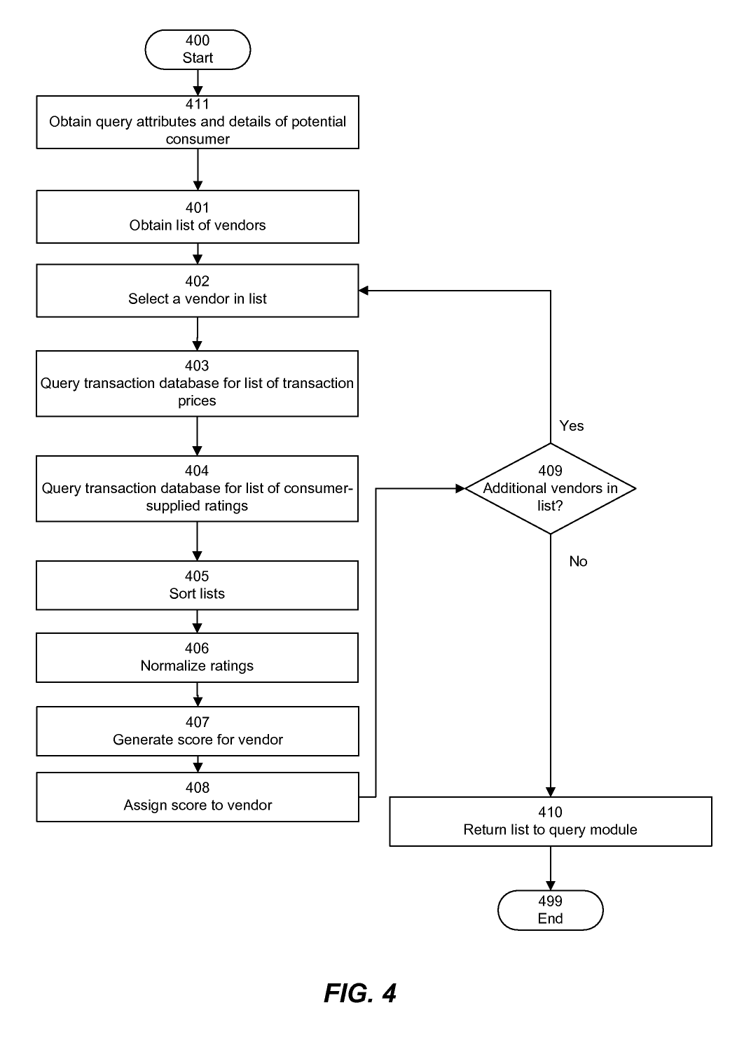

The scoring module 107 can use any known scoring algorithm. According to one embodiment, the scoring algorithm is a transaction-price weighted function of the consumer-supplied rating. Referring now to FIG. 4, there is shown a flow chart depicting a scoring algorithm for illustrative purposes. The scoring algorithm is described in connection with generating scores for vendors, but an equivalent scoring algorithm can be applied to products and/or services.

Query attributes and details of the potential consumer are obtained 411. A list of vendors, V that match the potential consumer's search query is obtained 401 from the search engine 109 via the query module 108. Potentially, a list of attributes or other qualifiers is also obtained from the query module 108. The scoring module 107 then selects 402 a vendor vᵢ, in the list V. For each vendor, the scoring module 107 queries 403 the transaction database 105 for a list of the transaction prices from all of the recorded transactions that involve vendor vᵢ, P with components pⱼ. The scoring module 107 also queries 404 the transaction database 105 for a list of the consumer-supplied ratings for all of the recorded transactions that involve vendor vᵢ, R, with components rⱼ.

Once the information has been received from the transaction database 105, the scoring module 107 sorts 405 the lists, P and R, such that for a given index, j, pⱼ and rⱼ represent the purchase price and the consumer-supplied rating for the same transaction. In one embodiment, if either component is missing from a transaction, the scoring module 107 discards all information regarding that transaction from the lists P and R.

In one embodiment, the scoring module 107 normalizes 406 the consumer-reported ratings, if they are not all in a common scale. For this example, various types of ratings can be mapped to a scale between −1 to 1.

The scoring module 107 then generates 407 a score, sᵢ, for vendor vᵢ as the transaction-price-weighted average of the consumer-supplied ratings, expressed for example as

$${s}_{i} = \frac{{\sum }_{j} {p}_{j} {r}_{j}}{{\sum }_{j} {p}_{j}}$$

where j is an index over all of the elements in the lists P and R. (P and R are equal length.)

The score sᵢ is assigned 408 to the vendor vᵢ. If there are additional vendors in the list 409, the method returns to step 402.

Once all vendors in the list have been processed, the scoring module 107 returns 410 the list of vendors, V, and their associated scores, to the query module 108.

The formula for the scoring algorithm is, in general, a function of both transaction prices and consumer-supplied ratings, and any other relevant information. That is, the score for the specific vendor i, is comprised of all the prices and ratings, j, that occurred with that vendor.

sᵢ=f(pⱼ,rⱼ, . . . )

The above-described scoring function is merely an example. One skilled in the art will recognize that other transaction-price-weighted rating functions can be used. For example, a function might be used that weights the consumer-supplied rating by transaction price, but that lessens the effect of very large purchases. For example:

$$\begin{matrix}{s}_{i} = \frac{{\sum }_{j} log ( {p}_{j} ) {r}_{j}}{{\sum }_{j} log ( {p}_{j} )} for all {p}_{j} > 1 where {p}_{j}^{′} \\ = \{ \begin{matrix}1 \text{:} {p}_{j} < 1 \\ {p}_{j} \text{:} 1 \leq {p}_{j} \leq 1 , 000 , 000 \\ 1 , 000 , 000 \text{:} {p}_{j} > 1 , 000 , 000\end{matrix}\end{matrix}$$

Here, a purchase of $10 would have a weight of 1, a purchase of $100 would have a weight of 2, and so on. Purchases below $1 would be discarded from the scoring algorithm and purchases over one million dollars would be capped at a weight of 6.

Another variation is to weight the score according to some affinity, or similarity (or lack thereof), between the consumer 104 that submitted a rating and the potential consumer 111 that requests the score. One possible scoring formula to accomplish this is:

$${s}_{i} = \frac{{\sum }_{j} {p}_{j} {r}_{j} {e}_{j}}{{\sum }_{j} {p}_{j} {e}_{j}}$$

which is the original transaction-price weighted average consumer-supplied rating but with an additional equivalency term eⱼ. This equivalency term is a function of some parameter, such as, for example, the age, sex and income bracket of both the potential consumer 111 who submitted the query and the consumer 104 involved in transaction j. In one embodiment, when the consumer 104 and potential consumer 111 are similar, the term tends towards 1. When the consumer 104 and potential consumer 111 are dissimilar, the term tends towards −1. In this way, a potential consumer 111 receives a list of scored vendors where the ratings provided by previous consumers 104 similar to the potential consumer 111 are more highly weighted. Further, different types of ratings (such as good/bad, numeric ratings, and the like) could be weighted differently from one another. In other embodiments, the generalized scores which include the equivalency factor take the form of

$${s}_{i} = \frac{{\sum }_{j} f ( {p}_{j} , {r}_{j} , {e}_{j} )}{{\sum }_{j} f ( {p}_{j} , {e}_{j} )} .$$

In one embodiment, the equivalency term in the scoring algorithm is used as a way to filter the transaction data used by scoring module 107 to trans-actions that match a particular filtering parameter. For example, a potential consumer 111 might only be interested in transactions involving other consumers 104 of his sex, age group, geographic location, and/or any other parameter. These parameters can be determined implicitly from characteristics of the potential consumer 111, and/or they can be explicitly specified in the search query.

### Reporting Scores

In one embodiment, a user can access a website to see scores generated by the present invention, and to compare scores for various vendors. Referring now to FIG. 5, there is shown an example of a screen shot of a report 500 showing scores, as presented by an embodiment of the invention. One skilled in the art will recognize that the particular layout and arrangement shown in FIG. 5 is merely exemplary, and that other layouts and arrangements are possible without departing from the essential characteristics of the present invention. For illustrative purposes, report 500 is shown as a website viewed in a browser; however, the invention can operate to deliver report 500 by other means as well.

The user can log in using link 507 to obtain customized ratings that take into account individual preferences and characteristics of the user. If the user has not yet created an account, he or she can click on link 506 to create a new account.

The user enters vendor search parameters, if desired, in fields 501, 502, and/or 503 to narrow down the list of vendors presented in report 500. For example, as shown in FIG. 5, the user may enter “restaurant” in field 501 to look for vendors that are restaurants, “Palo Alto, Calif.” in address field 502 to limit the search to vendors near that city, and a number in field 503 to specify a search radius in miles.

The user can also enter attributes in fields 504 to filter the displayed results so that they only include results from consumers matching the specified attributes. For example, the user can specify age range, gender, education level, income level, ethnicity, and/or any other attributes. The ability to specify such attributes increases the value of the received results, by making it more likely that the results will reflect preferences of consumers who are similar to the user.

Results are shown in box 5071, which may be scrollable. In the example, the following information is shown for each listing in box 5071:
Rank 510;
Vendor name 511;
Rating by dollars 512: a transaction-price-weighted average of consumer-supplied ratings;
Rating by score 513: an average of consumer-supplied ratings (not transaction-price-weighted);
Volume 514: total dollar value for goods/services provided by the vendor in connection with transactions used to generate the rating;
Distance 515: the distance from the address provided in box 502;
Number of ratings 516.

The user can sort by any column by clicking on the column header.

The user can select columns to be displayed in box 5071 by clicking on checkboxes 508. In the example, available information includes returns, number of users, variance, average transaction value, and the like (in addition to information described above).

In one embodiment, values shown in box 5071 are calculated based on the set of results as filtered by the attributes entered in fields 504. Thus, in one embodiment, these values are recalculated every time the user changes the attributes in fields 504. In another embodiment, at least some values are pre-computed and stored in a database at a server so that they can be displayed without any further calculation.

In one embodiment, the website is advertiser-supported. Accordingly, targeted ads 509 can be shown. These ads 509 can be selected based on known demographic information and preferences of the user.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference herein to “one embodiment”, “an embodiment”, or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be down-loaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs or distributed architectures for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method of collecting and providing consumer satisfaction ratings, comprising:
for each of a plurality of transactions between consumers and providers:
receiving information describing a transaction between a consumer and a provider, the information being received from a source independent of the consumer and the provider;
receiving information describing the consumer;
receiving information describing the provider;
receiving an indicator of consumer satisfaction regarding at least one of the transaction and the provider;
associating the transaction information with the consumer satisfaction indicator; and
storing the transaction information, the consumer information, the provider information, and the consumer satisfaction indicator;
for each of at least a subset of the providers, generating a score, wherein the score comprises a transaction-price-weighted function of at least a subset of the consumer satisfaction indicators for the provider; and
outputting the generated scores.

2. The method of claim 1, wherein receiving the information describing the transaction comprises receiving the information from a financial institution.

3. The method of claim 1, further comprising:
receiving at least one filtering parameter specifying at least one selected from the group consisting of;
a characteristic of a consumer; and
a characteristic of a provider;
and wherein generating a score comprises generating a score based on consumer satisfaction indicators corresponding to transactions matching the at least one filtering parameter.

4. The method of claim 1, wherein receiving the information describing the transaction comprises receiving a monetary amount associated with the transaction.

5. The method of claim 1, wherein receiving the indicator of consumer satisfaction comprises receiving input from the consumer indicating a degree of satisfaction.

6. The method of claim 1, wherein receiving the indicator of consumer satisfaction comprises inferring a degree of satisfaction from observed consumer behavior.

7. The method of claim 1, wherein generating a score comprises generating a consumer satisfaction score based on:
received indicators of consumer satisfaction; and
received information describing monetary amounts associated with trans-actions for the consumers.

8. The method of claim 7, wherein generating a score further comprises:
adjusting the generated score to diminish weights of multiple ratings from a single consumer for a single provider.

9. The method of claim 1, further comprising ranking the providers according to the scores, and wherein outputting the generated scores comprises outputting a ranked list of providers.

10. The method of claim 1, further comprising, prior to outputting the generated score:
receiving a query from a potential consumer, the query specifying at least one parameter; and
responsive to the query, identifying a set of providers satisfying the at least one parameter;
and wherein generating a score comprises generating a score for each of the providers in the identified set.

11. The method of claim 10, further comprising, prior to outputting the generated score:
determining at least one characteristic of the potential consumer;
for at least one consumer satisfaction indicator:
determining at least one characteristic of the associated consumer;
determining a degree of equivalence between the determined characteristic of the potential consumer and the determined characteristic of the consumer associated with the indicator; and
adjusting the consumer satisfaction indicator according to the determined degree of equivalence.

12. The method of claim 1, further comprising, prior to outputting the generated score:
determining at least one characteristic of the potential consumer;
for at least one consumer satisfaction indicator:
determining at least one characteristic of the associated consumer;
determining a degree of equivalence between the determined characteristic of the potential consumer and the determined characteristic of the consumer associated with the indicator; and
adjusting the consumer satisfaction indicator according to the determined degree of equivalence.

13. The method of claim 1, wherein each provider comprises a service provider.

14. The method of claim 1, wherein each provider comprises a seller of goods.

15. The method of claim 1, wherein receiving information describing the consumer comprises receiving at least some information from the consumer.

16. The method of claim 1, wherein generating a score comprises weighting each consumer satisfaction indicator by a corresponding transaction price and generating an average based on the weighted consumer satisfaction indicators.

17. The method of claim 1, wherein generating a score is performed prior to a request for the score.

18. A method of collecting and providing satisfaction ratings, comprising:
for each of a plurality of transactions between a first group of entities and a second group of entities:
receiving information describing a transaction between an entity in the first group and an entity in the second group, the information being received from a source independent of the entities;
receiving information describing the entity in the first group;
receiving information describing the entity in the second group;
receiving an indicator of satisfaction regarding the transaction;
associating the transaction information with the satisfaction indicator; and
storing the transaction information, the information describing the entities, and the satisfaction indicator;
for each of at least a subset of entities in the second group, generating a score, wherein the score comprises a transaction-price-weighted function of at least a subset of the satisfaction indicators for the entity in the second group; and
outputting the generated scores.

19. A computer program product for collecting and providing consumer satisfaction ratings, comprising:
a computer-readable storage medium; and
computer program code, encoded on the medium, programmatically configured to perform the steps of:
for each of a plurality of transactions between a first group of entities and a second group of entities:
receiving information describing a transaction between an entity in the first group and an entity in the second group, the information being received from a source independent of the entities;
receiving information describing the entity in the first group;
receiving information describing the entity in the second group;
receiving an indicator of satisfaction regarding the transaction;
associating the transaction information with the satisfaction indicator; and
storing the transaction information, the information describing the entities, and the satisfaction indicator;
for each of at least a subset of entities in the second group, generating a score, wherein the score comprises a transaction-price-weighted function of at least a subset of the satisfaction indicators for the entity in the second group; and
outputting the generated scores.

20. The computer program product of claim 19, wherein:
the first group of entities comprises consumers; and
the second group of entities comprises providers.

21. The computer program product of claim 19, wherein the computer program code for generating a score comprises computer program code for weighting each satisfaction indicator by a corresponding transaction price and generating an average based on the weighted satisfaction indicators.

22. A system for collecting and providing consumer satisfaction ratings, comprising:
a transaction data collection module, for, for each of a plurality of transactions between a first group of entities and a second group of entities:
receiving information describing a transaction between an entity in the first group and an entity in the second group, the information being received from a source independent of the entities;
receiving information describing the entity in the first group; and
receiving information describing the entity in the second group;
a feedback module, for, for each transaction in the plurality, receiving an indicator of satisfaction regarding the transaction;
a database coupled to the transaction data collection module and the feedback module, for:
associating the transaction information with the satisfaction indicator; and
storing the transaction information, the information describing the entities, and the satisfaction indicator;
a scoring module, coupled to the database, for, for each of at least a subset of entities in the second group, generating a score, wherein the score comprises a transaction-price-weighted function of at least a subset of the satisfaction indicators for the entity in the second group; and
an output device, coupled to the scoring module, for outputting the generated scores.

23. The system of claim 22, wherein:
the first group of entities comprises consumers; and
the second group of entities comprises providers.

24. The system of claim 22, wherein the scoring module generates a score by weighting each consumer satisfaction indicator by a corresponding transaction price and generating an average based on the weighted satisfaction indicators.
